(19) United States
(12) Patent Application Publication
(10) Pub. No.: US 2009/0044472 A1
(43) Pub. Date: Feb. 19, 2009

(54) WALLPAPER WITH ERASABLE FRONT MATCH MARKS

(75) Inventor: Patrick J. Bluett, Largo, FL (US)

Correspondence Address: LARSON AND LARSON, 11199 69TH STREET NORTH, LARGO, FL, 33773, US

(73) Assignee: SCHOONER PRINTS, INC., Largo, FL (US)

(21) Appl. No.: 11/840,077

(22) Filed: Aug. 16, 2007

(51) Int. Cl. E04F 13/00; B44C 7/06

(52) U.S. Cl. 52/311.2; 156/63

(57) ABSTRACT

An application for wallpaper with match marks includes a continuous sheet of wallpaper having a front surface, a back surface, a left edge and a right edge and a decorative pattern printed on the front surface. A plurality of erasable left match marks are spaced along the left edge of the front surface and a plurality of erasable right match marks spaced along the right edge of the front surface.

### BACKGROUND OF THE INVENTION

This application is related to U.S. application titled, “METHOD AND APPARATUS FOR MANUFACTURING WALLPAPER WITH ERASABLE FRONT MATCH MARKS,” which was filed on even date herewith; attorney docket number 2380.1 and inventor Patrick J. Bluett.

### FIELD OF THE INVENTION

This invention relates to the field of positioning wallpaper and more particularly to matching two abutting sheets of wallpaper.

### DESCRIPTION OF THE RELATED ART

Wallpaper is applied to a surface such as a wall in wide varieties of ways. Typically, wallpaper is applied to the entire wall surface and often to all or most of the wall surfaces in a room.

Wallpaper is typically provided in rolls. Sheets of the approximate height of the wall are cut, water is applied to pre-pasted wallpaper or adhesive applied to un-pre-pasted wallpaper and the sheet is placed on the wall, adhesive side down, each sheet next to the previous sheet until the desired area is covered.

Wallpaper comes in a wide variety of designs and patterns. As an example, one such wallpaper has a paisley pattern, having designs of paisley interspersed regularly across its surface. When two strips of wallpaper are to be placed next to each other, an aesthetic or other acceptable match of the two pieces of wallpaper can be obtained if the pattern on the wallpaper is subtle e.g. does not have a large dominant feature. However if the wallpaper does have a dominant feature such as the paisley pattern, it is preferable that the abutting sheets of the wallpaper are abutted such that the pattern flows across the entire wall and/or room.

Typically, a pattern on wallpaper repeats at fixed intervals such as every two feet. To align such wallpaper, often a reference line is printed on each side of the back surface of the wallpaper. To successfully align the pattern, the right reference line of the first sheet needs to line up with the left reference line of the sheet to its right, and so forth. Unfortunately, once the first sheet is hung, it is difficult to find the location of the reference line being that the reference line is against the wall. Often, the wallpaper hanger will mark the wall with a pencil next to the location of the reference mark. That withstanding, when hanging the second sheet, it is difficult to find and see the pencil mark since it is covered by the second sheet and it is difficult to see/find the reference mark on the second sheet since it is on the adhesive side of the wallpaper.

U.S. Pat. No. 6,024,821 to Cousineau describes a method of matching wallpaper borders using a clear plastic sheet. This method requires extra tools and is not described for matching wallpaper, only borders.

What is needed is a wallpaper matching and alignment system that will improve the ease at which wallpaper with patterns is hung.

### SUMMARY OF THE INVENTION

In one embodiment, wallpaper with match marks is disclosed including a continuous sheet of wallpaper having a front surface, a back surface, a left edge and a right edge and a decorative pattern printed on the front surface. A plurality of erasable left match marks are spaced along the left edge of the front surface and a plurality of erasable right match marks spaced along the right edge of the front surface.

In another embodiment, a method of hanging wallpaper is disclosed including (1) providing wallpaper with match marks, the wallpaper is a continuous sheet with a front surface, a back surface, a left edge and a right edge and has a decorative pattern printed on its front surface. The wallpaper also has a plurality of erasable left match marks spaced along the left edge of the front surface and a plurality of erasable right match marks spaced along the right edge of the front surface. The method continues with (2) either applying water (for pre-pasted wallpaper) or applying paste to the back surface of a first sheet of the wallpaper and (3) hanging the first sheet of wallpaper vertically on a wall. Next, (4) paste is applied to the back surface of a next sheet of the wallpaper and (5) the next sheet of wallpaper is hung vertically on the wall, aligning the right match marks of the first sheet of wallpaper with the left match marks of the next sheet of wallpaper. (6) If more sheets of wallpaper need be hung, steps 4 and 5 are repeated. After each sheet of wallpaper is hung or when the job is completed, (7) the left match marks and the right match marks are erased using a moist instrument such as a sponge.

In another embodiment, wallpaper is disclosed including a continuous sheet of wallpaper having a front surface, a back surface, a left edge and a right edge with a decorative pattern printed on the front surface. A first part of a scheme for aligning multiple sheets of the wallpaper is spaced along the left edge of the front surface and a second part of a scheme for aligning multiple sheets of the wallpaper spaced along the right edge of the front surface.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a match marking system of the present invention.

FIG. 2 illustrates a schematic view of a match marking system of the present invention after the match marks have been removed.

FIG. 3 illustrates an isometric view of a roll of wallpaper of the present invention showing the match marks.

FIG. 4 illustrates a typical printing device of the present invention for printing the match marks.

FIG. 5 illustrates a plan view of a typical wallpaper printing operation of the present invention.

FIG. 6 illustrates a flow chart of a method of hanging wallpaper using the match marks of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

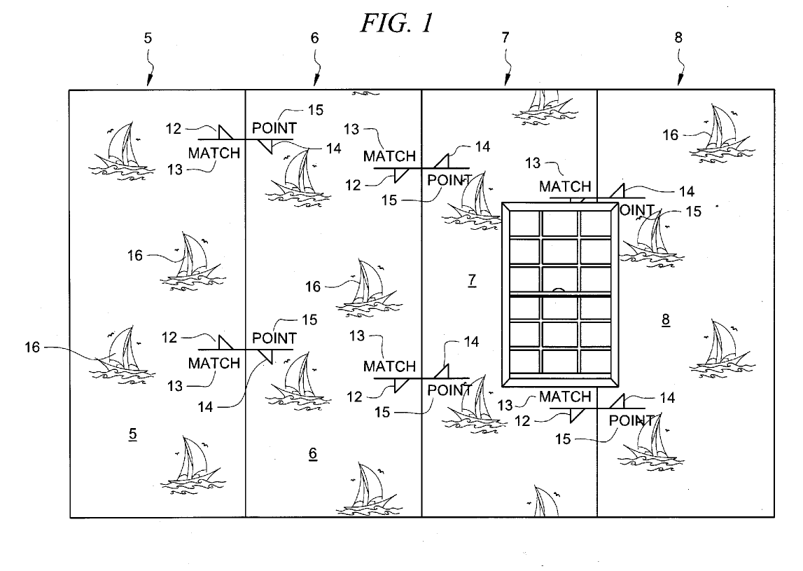

Referring to FIG. 1, a schematic view of a match marking system of the present invention will be described. In this typical wallpaper with a pattern 16, it can be seen that the pattern 16 repeats, in that in each successive sheet of wallpaper 5/6/7/8. To achieve a desired level of aesthetic appeal, it is important that the patterns of each successive sheet 5/6/7/8 align with the previous sheet 5/6/7/8 so that the pattern continues across the entire covered surface. For example, in the simple pattern shown, the sail boats 16 align on a slight downward angle to the right. In other words, a sail boat 16 in the second sheet 6 is slightly lower than its corresponding sail boat 16 of the previous sheet (left) 5 and that follow through to the next sheet where a sail boat 16 in the third sheet 7 is slightly lower than its corresponding sail boat 16 of the second sheet 6, and so forth. In this way, the pattern runs across the entire surface or wall. Without a method of aligning the sheets of wallpaper 5/6/7/8, the pattern (sail boats 16) would be random and would not be aesthetically pleasing when viewed at a distance.

To achieve this alignment, match marks 12/13/14/15 are printed on the face of the wallpaper. When hanging the wallpaper 5/6/7/8, a paper hanger will typically start by applying a first sheet to the surface (wall) using wallpaper paste (note, some wallpaper is pre-pasted and need only be wet to activate the paste). The first sheet 5 is hung vertically on the wall and a second sheet 6 is prepared and hung to the right of the first sheet 5. In order to assure correct pattern matching, the right edge match marks 12 of the first sheet 5 is aligned with the left edge match marks 14 of the second sheet 6. Although the match marks 12/13/14/15 are shown with arrows 12/14 and words POINT 15 and MATCH 13, any marking is envisioned that provides for alignment of one sheet to a subsequent sheet of wallpaper.

Once the wallpaper 5/6/7/8 is hung and aligned correctly, there is no further need for the match marks 12/13/14/15. Actually, the finished wall would not look good if the match marks 12/13/14/15 remained. Therefore, it is important that the match marks 12/13/14/15 be easily removable, preferably with a soft, wet cloth, sponge or the like. This is achieved through the use of inks that do not permeate into the wallpaper and are erasable when wetted with water.

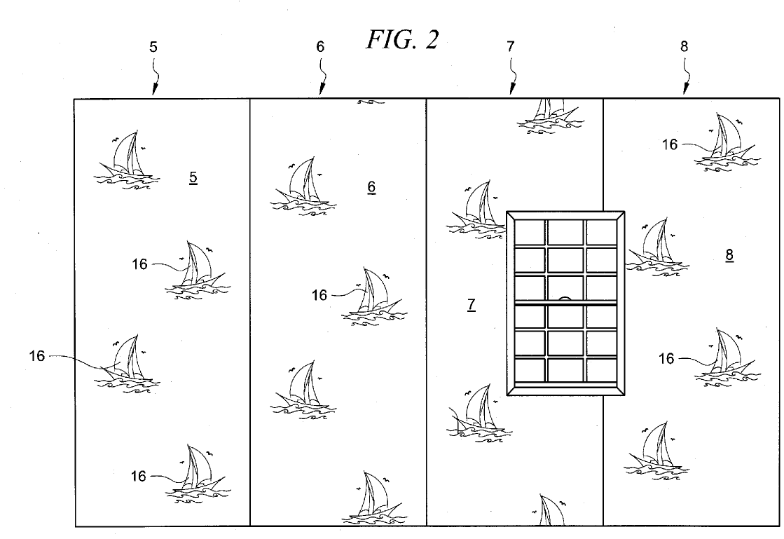

Referring to FIG. 2, a schematic view of a match marking system of the present invention after the match marks have been removed will be described. The sheets of wallpaper 5/6/7/8 are correctly hung and the patterns 16 flow correctly across the multiple sheets 5/6/7/8. In FIG. 2, there are no match marks remaining. The match marks 12/13/14/15 as shown in FIG. 1 were removed using a moistened instrument such as a wash cloth, rag, sponge, etc. It is preferred that the ink used to print the match marks be capable of being erased with minimal friction using water and such an instrument. It is also preferred that the ink be such that the ink dies not sublimate into the wallpaper, especially on very porous wallpaper surfaces.

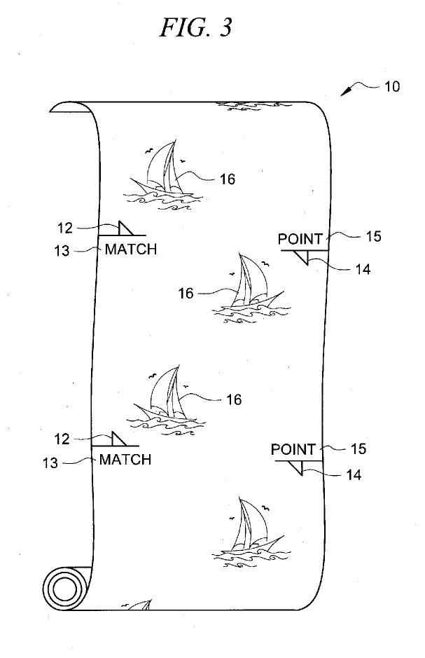

Referring to FIG. 3, an isometric view of a roll of wallpaper of the present invention showing the match marks will be described. Wallpaper 10 is normally provided on rolls as shown in FIG. 3. The wallpaper 10 of the present invention has match marks 12/13/14/15 for example, the left side arrow 12 that matches with the right side arrow 14. In some embodiments, words 13/15 are printed above or below the arrows 12/14 to call attention to the arrows 12/14, for example, “MATCH” 13 and “POINT” 15. Many other match markings are possible in various shapes, styles, sizes and wording, all of which are included in the present invention.

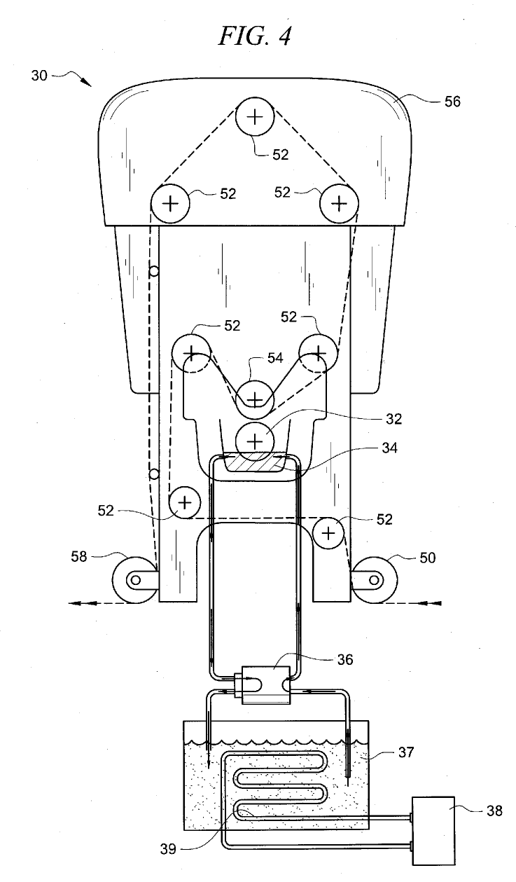

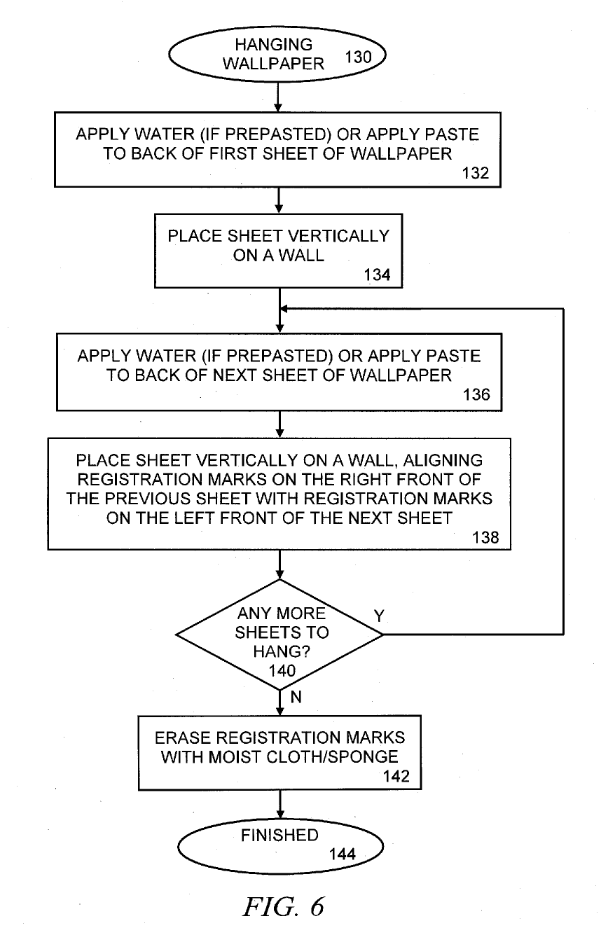

Referring to FIG. 4, a typical printing device of the present invention for printing the match marks will be described. The wallpaper printing device 30 has an input roller 50 for accepting a continuous sheet of wallpaper from previous printing devices (see FIG. 6). In some embodiments, the input roller 50 contains a chiller roller as known in the industry for cooling the wallpaper before it enters the print rollers 32/54. The wallpaper is guided by guide rollers 52 to the actual print mechanism that comprises a print cylinder 32 with the pattern (e.g., match marks 12/13/14/15) and a pressure roller 54 that provides pressure to the wallpaper so it can accept the pattern from the print cylinder 32. The print cylinder 32 picks up ink from an ink tray 34 as it rotates. In some embodiments, a doctor blade (not shown) wipes off excess ink before the print cylinder 32 rotates beneath the wallpaper. The wallpaper with the printed match marks 12/13/14/15 then passes over additional guide rollers 52 through a heating area 56 to dry the inks and finally, the wallpaper passes around an output roller 58 to the roll processing area where it is rolled, cut and packaged. In some embodiments, the output roller 58 contains a chiller roller as known in the industry for cooling the wallpaper before it enters the roll processing area.

The ink used to print the match marks 12/13/14/15 needs to be kept at a low temperature so it does not coagulate in the ink tray 34 or on the rollers. One such ink is “Aqua Safe Removable Ink” number 7.2377 from Polytex Environmental Inks, 820 East 140th Street Bronx, N.Y. 10454. To keep the ink at a low temperature, the ink is constantly cycled from a reservoir 37 through the ink tray 34 and back to the reservoir 37 by a pump 36. The ink in the reservoir 37 is cooled by refrigeration coils 39 that are fluidly interfaced with a refrigeration unit 38 as known in the industry. In the preferred embodiment, the refrigeration coils 39 are immersed in the ink in the reservoir 37 (as shown). In alternate embodiments, the refrigeration coils 39 are disposed around the perimeter of the reservoir 37 or as known in the industry. Other methods of cooling the ink are known in the industry and included here within.

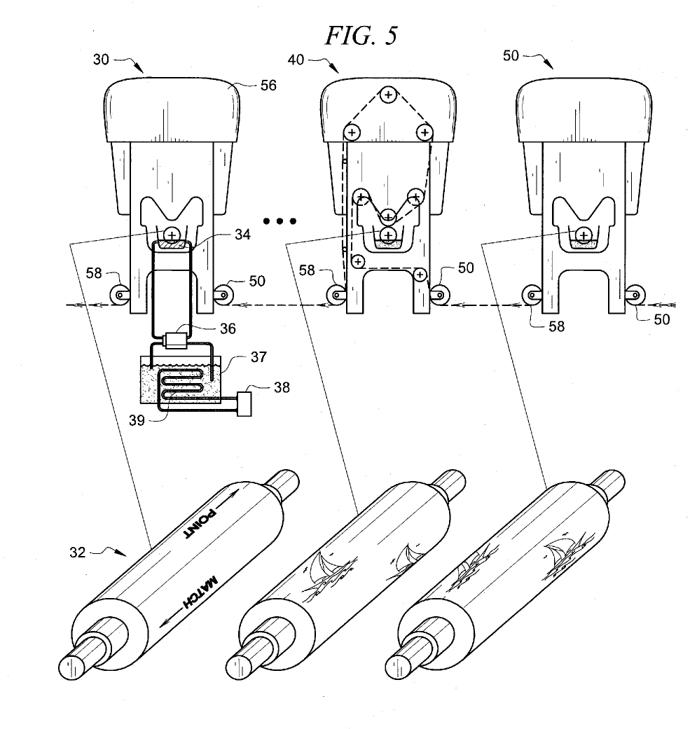

Referring to FIG. 5, a plan view of a typical wallpaper printing operation of the present invention will be described. A continuous feed of blank wallpaper enters a first printing device 70 and is printed with a first pattern 72 as known in the industry. After passing through the drier of the printing device 50, the continuous sheet of wallpaper exits the first printing device 70 and enters the second printing device 60 and is printed with a second pattern 62 as known in the industry. It is well known how to print different sections or colors of a pattern using different print cylinders (e.g., the first print cylinder 72 and second print cylinder 62) with different color inks, etc. It is anticipated that, depending upon the pattern and number of colors, several printing devices 60/70 are used. This is well known in the industry. Although the match mark 12/13/14/15 is preferably printed on the face of the wallpaper by the print mechanism 30 after the pattern is printed, in alternate embodiments, it is printed before the pattern or in between other print steps.

In the example shown, the final print stage is a print device 30 for printing the match mark 12/13/14/15. This stage uses the ink cooling mechanism as described above consisting of the ink tray 34 fluidly coupled to the ink reservoir 37 by a pump 36. The ink in the reservoir 37 is cooled by coiling tubes/coil 39 that is/are fluidly coupled to a refrigeration unit 38.

Referring to FIG. 6, a flow chart of a method of hanging wallpaper using the match marks of the present invention will be described. The described process for hanging wallpaper using the match marks of the present invention is abbreviated for clarity. Those skilled in the art will realize that hanging wallpaper requires cutting the sheets to the approximate height of the walls, if needed, trimming the sheets, making sure the sheets are applied vertically using a plumb bob, etc., and after the paper is hung, trimming and smoothing the paper. These steps are well known in the industry and are omitted to clearly describe the present invention. Also, some wallpaper is pre-pasted and, instead of applying paste as in steps 132 and 136, the paste on the backing of the wallpaper is moistened with water.

Hanging 130 begins with applying water or paste to a sheet of wallpaper 132 (the wallpaper is cut slightly longer than the height of the wall). Next, the sheet is placed vertically on the wall 134 (a plumb line is often used to assure a vertical hanging). Paste or water is then applied to the next sheet 136 and it is placed on the wall next to the previous sheet such that the match marks on the face of the right side of the first (previous) sheet align with the match marks on the face of the left side of the next sheet 138. If more sheets of wallpaper need to be hung 140, the previous two steps 136/138 are repeated until the wall is covered. Once finished hanging the wallpaper, the match marks on the face of the wallpaper are removed using a moistened cloth, sponge or other instrument and a slight rubbing motion 142 and the job is finished 144.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. Wallpaper with match marks, the wallpaper comprising:
a continuous sheet of wallpaper having a front surface, a back surface, a left edge and a right edge;
a decorative pattern printed on the front surface;
a plurality of erasable left match marks spaced along the left edge of the front surface; and
a plurality of erasable right match marks spaced along the right edge of the front surface.

2. The wallpaper with match marks of claim 1, wherein the plurality of erasable right match marks and the plurality of erasable left match marks are printed on the front surface with ink, the ink erasable with water.

3. The wallpaper with match marks of claim 2, wherein the plurality of erasable right match marks includes arrows pointing toward the right edge.

4. The wallpaper with match marks of claim 2, wherein the plurality of erasable left match marks includes arrows pointing toward the left edge.

5. The wallpaper with match marks of claim 3, wherein the plurality of erasable right match marks further includes words printed near the arrows pointing toward the right edge.

6. The wallpaper with match marks of claim 4, wherein the plurality of erasable left match marks further includes words printed near the arrows pointing toward the left edge.

7. A method of hanging wallpaper comprising:
(1) providing pre-pasted wallpaper with match marks, the wallpaper comprising:
a continuous sheet of wallpaper having a front surface, a back surface, a left edge and a right edge;
a decorative pattern printed on the front surface;
a plurality of erasable left match marks spaced along the left edge of the front surface; and
a plurality of erasable right match marks spaced along the right edge of the front surface;
(2) wetting the paste to the back surface of a first sheet of the wallpaper;
(3) hanging the first sheet of the wallpaper vertically on a wall;
(4) wetting the paste to the back surface of a next sheet of the wallpaper;
(5) hanging the next sheet of the wallpaper vertically on a wall, aligning the erasable right match marks of the first sheet of wallpaper with the erasable left pre-pasted marks of the next sheet of wallpaper;
(6) if more sheets of the wallpaper need be hung, repeat steps 4 through 6; and
(7) erasing the left match marks and the right match marks using a moist instrument.

8. The method of claim 7, wherein the moist instrument is a sponge.

9. The method of claim 7, wherein the plurality of erasable right match marks and the plurality of erasable left match marks are printed on the front surface with ink, the ink erasable with water.

10. The method of claim 9, wherein the plurality of erasable right match marks includes arrows pointing toward the right edge.

11. The method of claim 9, wherein the plurality of erasable left match marks includes arrows pointing toward the left edge.

12. The method of claim 10, wherein the plurality of erasable right match marks further includes words printed near the arrows pointing toward the right edge.

13. The method of claim 11, wherein the plurality of erasable left match marks further includes words printed near the arrows pointing toward the left edge.

14. Wallpaper comprising:
a continuous sheet of wallpaper having a front surface, a back surface, a left edge and a right edge;
a decorative pattern printed on the front surface;
a first part of a means for aligning multiple sheets of the wallpaper spaced along the left edge of the front surface; and
a second part of a means for aligning multiple sheets of the wallpaper spaced along the right edge of the front surface.

15. The wallpaper of claim 14, wherein the first part of a means for aligning multiple sheets of the wallpaper and the second part of a means for aligning multiple sheets of the wallpaper are printed on the front surface with ink, the ink erasable with water.

16. The wallpaper of claim 15, wherein the second part of a means for aligning multiple sheets of the wallpaper includes arrows pointing toward the right edge.

17. The wallpaper of claim 15, wherein the first part of a means for aligning multiple sheets of the wallpaper includes arrows pointing toward the left edge.

18. The wallpaper of claim 16, wherein the second part of a means for aligning multiple sheets of the wallpaper further includes words printed near the arrows pointing toward the right edge.

19. The wallpaper of claim 17, wherein the first part of a means for aligning multiple sheets of the wallpaper further includes words printed near the arrows pointing toward the left edge.
